(19) United States
(12) Patent Application Publication
(10) Pub. No.: US 2026/0182756 A1
(43) Pub. Date: Jul. 2, 2026

(54) CERTIFICATE DISPLAY STAND

(71) Applicant: Eunice Callwood, Charlotte Amalie, VI (US)

(72) Inventor: Eunice Callwood, Charlotte Amalie, VI (US)

(21) Appl. No.: 19/001,986

(22) Filed: Dec. 26, 2024

(51) Int. Cl. A47G 1/14; F16M 11/22

(52) U.S. Cl. CPC A47G 1/142; F16M 11/22; A47G 2001/147

(57) ABSTRACT

A certificate display stand includes a base, a post projecting vertically from the base, a plurality of arms coupled to the post, and a plurality of sleeves. Each of the arms is positioned to project from the post in a direction perpendicular to a vertical axis of the post. Each of the sleeves is transparent and designed to hold a certificate. Each of the sleeves is suspended from a respective one of the arms.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

### (1) Field of the Invention

The disclosure relates to stands and displays for cards and similar items and more particularly pertains to a new certificate display stand for displaying certificates, such as certificates indicating a credential earned or an achievement accomplished. For example, a professional in the medical or legal fields will earn educational and professional certifications relating to the profession which the professional may wish to display. The certificate display stand provides a way to display several of such certificates in a compact, decorative, and easily viewable manner.

### (2) Description of Related Art Including Information Disclosed Under 37 CFR 1.97 and 1.98.

The prior art relates to stands and displays for cards and similar items. The prior art, as best understood, does not disclose a stand with a plurality of arms extending radially from a central post that have transparent sleeves suspended from the arms to display certificates, such as for credentials or achievements.

### BRIEF SUMMARY OF THE INVENTION

An embodiment of the disclosure meets the needs presented above in a certificate display stand generally comprising a base, a post projecting vertically from the base, a plurality of arms coupled to the post, and a plurality of sleeves. Each of the arms is positioned to project from the post in a direction perpendicular to a vertical axis of the post. Each of the sleeves is transparent and designed to hold a certificate. Each of the sleeves is suspended from a respective one of the arms.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a certificate display stand according to an embodiment of the disclosure.

FIG. 2 is a top front perspective view of an embodiment of the disclosure.

FIG. 3 is a top front perspective view of an embodiment of the disclosure in use.

FIG. 4 is a front view of an embodiment of the disclosure.

FIG. 5 is a close-up view of a component of an embodiment of the disclosure.

FIG. 6 is a cross-sectional view of a component of an embodiment of the disclosure in FIG. 5.

FIG. 7 is close-up view of a component of an embodiment of the disclosure in use.

FIG. 8 is a cross-sectional view of a component of the embodiment of the disclosure in FIG. 7.

FIG. 9 is a perspective view of an alternative embodiment of the disclosure.

### DETAILED DESCRIPTION OF THE INVENTION

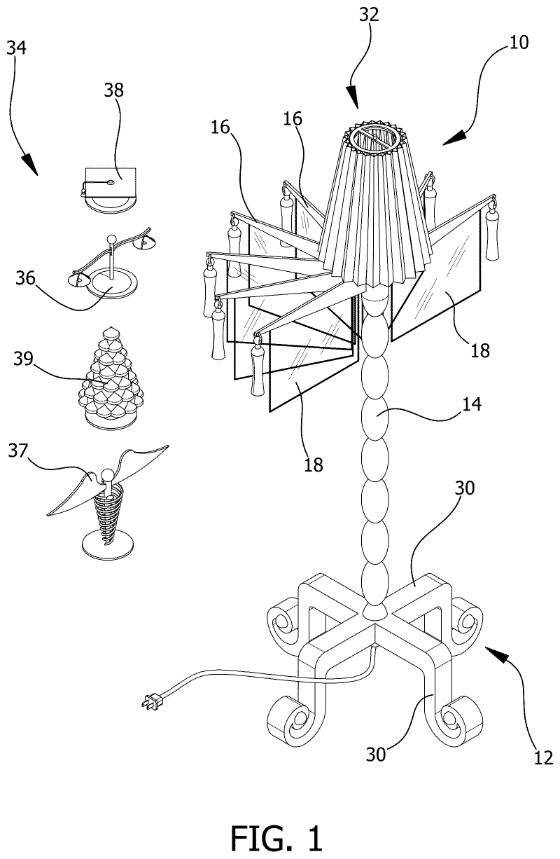

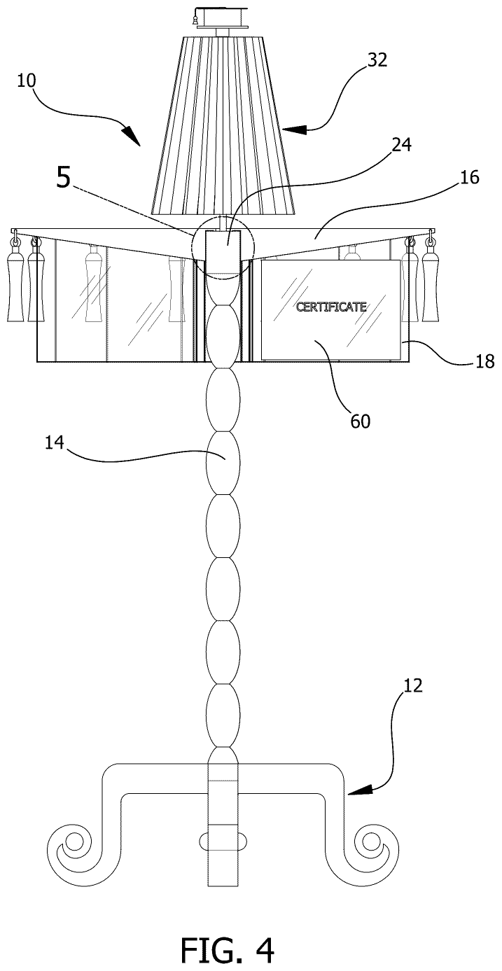

With reference now to the drawings, and in particular to FIGS. 1 through 9 thereof, a new certificate display stand embodying the principles and concepts of an embodiment of the disclosure and generally designated by the reference numeral 10 will be described.

As best illustrated in FIGS. 1 through 9, the certificate display stand 10 generally comprises a base 12, a post 14 projecting vertically from the base 12, a plurality of arms 16 coupled to the post 14, and a plurality of sleeves 18. Each of the arms 16 is positioned to project from the post 14 in a direction perpendicular to a vertical axis of the post 14. Each of the sleeves 18 is transparent and designed to hold a certificate 60. Each of the sleeves 18 is suspended from a respective one of the arms 16.

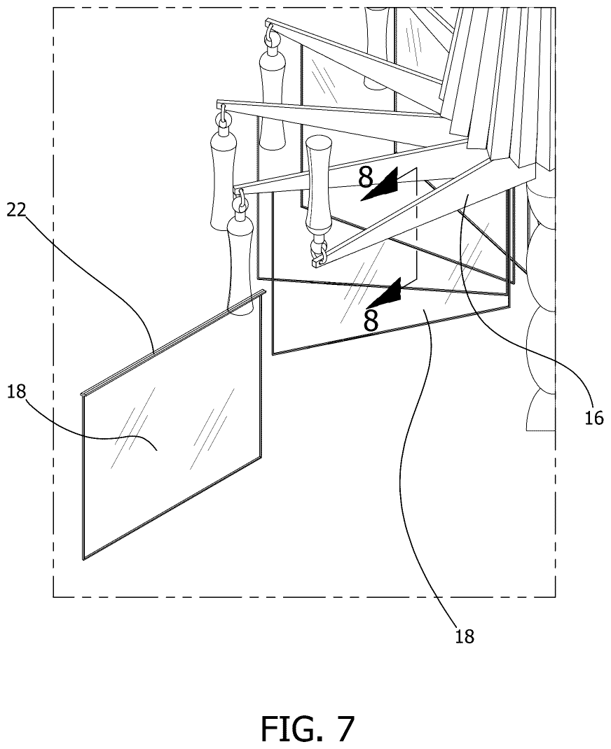

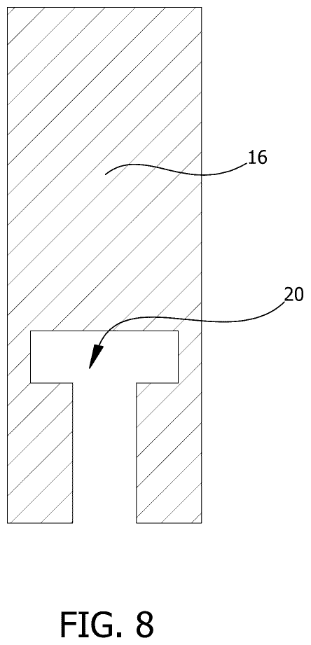

As shown in FIG. 7, each of the sleeves 18 is detachably coupled to a respective one of the arms 16. In the exemplary embodiment in FIGS. 7 and 8, each of the arms 16 includes a slot 20. Each of the sleeves 18 includes an edge 22 designed to be inserted into the slot 20 to suspend each of the sleeves 18 in a direction radial to a longitudinal axis of a respective one of the arms 16. The slot 20 is T-shaped and the edge 22 is T-shaped to engage with the slot 20. However, other designs, such as a rounded shape or L-shape, are within the scope of the disclosure.

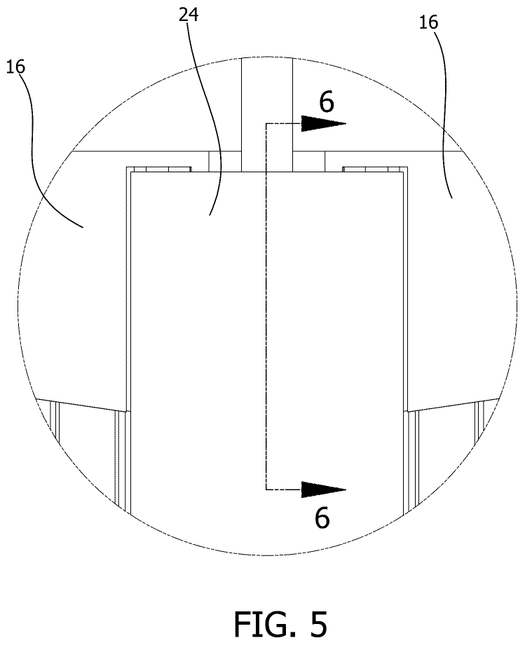

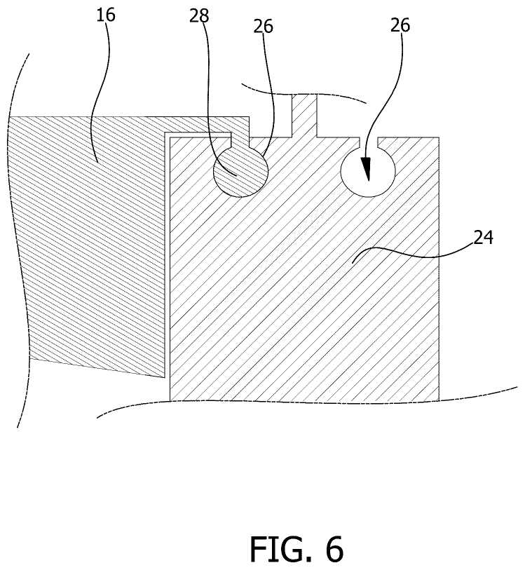

As shown in the exemplary embodiment in FIGS. 5 and 6, the post 14 includes a hub 24 to which the arms 16 are coupled. The hub 24 includes a groove 26 that is circular and positioned about the vertical axis of the post 14. Each of the arms 16 includes a projection 28 positioned in the groove 26. The projection 28 is slidable in the groove 26 such that the arms 16 are movable about the hub 24 to different positions. The arms 16 could be movably coupled in other ways that are well known in the mechanical arts.

In the exemplary embodiment, the base 12 includes a plurality of legs 30. However, the base 12 could be another design, such as a platform that is rounded or rectangular. In addition, the certificate display stand 10 further includes a light fixture 32 coupled to the post 14 above the arms 16. The light fixture 32, which could be omitted in another possible embodiment, can illuminate a room as well as the certificates 60.

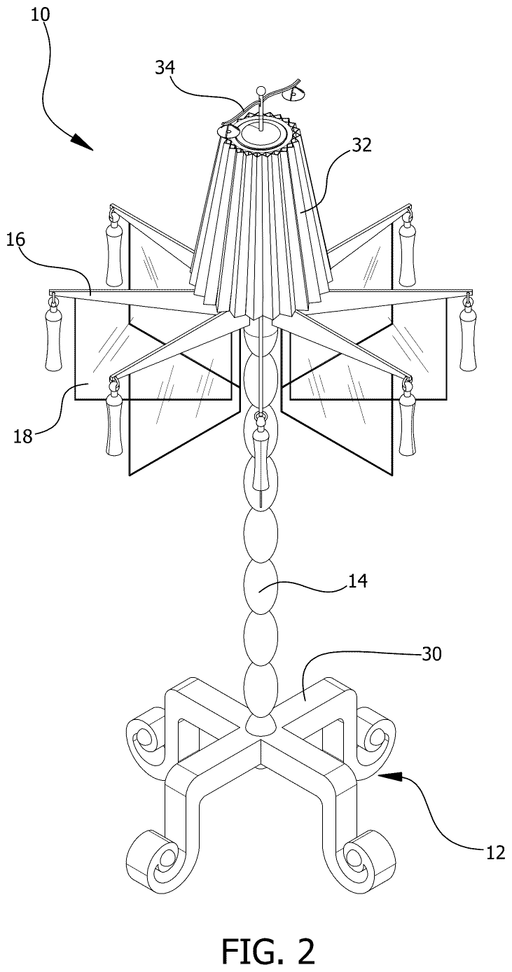

As shown in FIG. 2, the certificate display stand 10 further includes a finial 34 coupled to a top end of the post 14. As shown in FIG. 1, the finial 34 can include a sculpture representing common subject matter of the certificates 60 in the sleeves 18, such as a scale 36 for legal, a caduceus 37 for medical, or a cap 38 for educational. The finial 34 could also be just a decorative design, such as the cone or tree structure 39 in FIG. 1. Virtually any type of finial 34 could be utilized as desired.

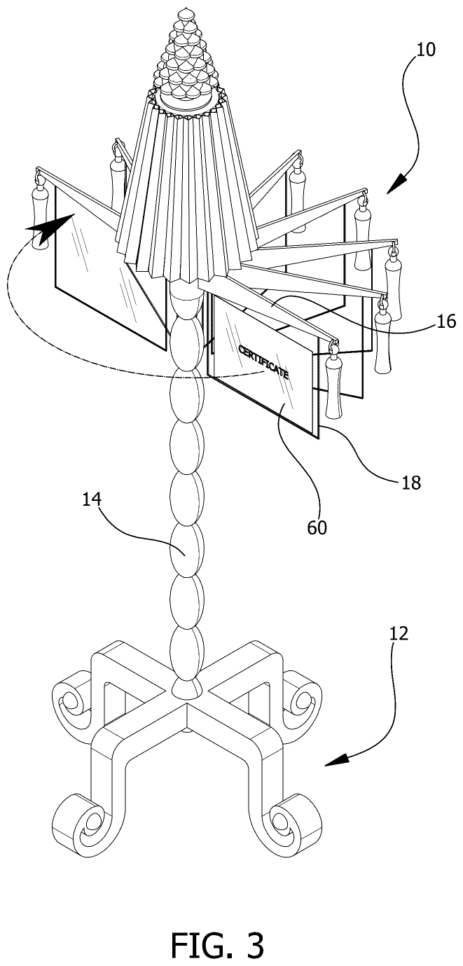

As discussed above, the certificate display stand 10 is used to display the certificates 60. An individual certificate 60 is placed in one of the sleeves 18. As shown in FIG. 3, the sleeve 18 then can be slid into one of the arms 16. The user can rotate the arms 16, and thus the sleeves 18, around the hub 24 to view the certificates 60.

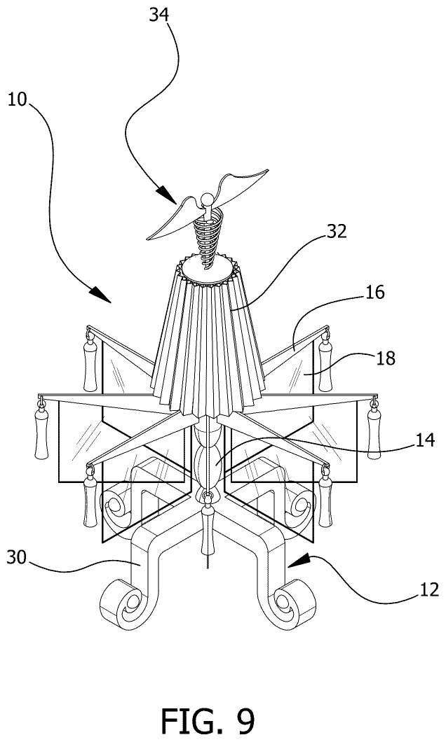

FIG. 9 shows an alternative embodiment of the certificate display stand 10 that is much shorter than the embodiment in FIGS. 1 through 8. The alternative embodiment is suitable for smaller spaces, such as on top of a desk or end table, as opposed to being freestanding on a floor or similar.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A certificate display stand comprising:
a base;
a post projecting vertically from said base;
a plurality of arms being coupled to said post, each of said arms being positioned to project from said post in a direction perpendicular to a vertical axis of said post; and
a plurality of sleeves, each of said sleeves being suspended from a respective one of said arms, each of said sleeves being transparent and configured to hold a certificate.

2. The certificate display stand of claim 1, wherein each of said sleeves is detachably coupled to a respective one of said arms.

3. The certificate display stand of claim 2, wherein:
each of said arms includes a slot; and
each of said sleeves includes an edge configured to be inserted into said slot to suspend each of said sleeves in a direction radial to a longitudinal axis of a respective one of said arms.

4. The certificate display stand of claim 3, wherein said slot is T-shaped and said edge is T-shaped to engage with said slot.

5. The certificate display stand of claim 1, wherein:
said post includes a hub to which said arms are coupled;
said hub includes a groove that is circular and positioned about the vertical axis of the post;
each of said arms includes a projection positioned in said groove; and
said projection is slidable in said groove such that said arms are movable about said hub to different positions.

6. The certificate display stand of claim 1, wherein said base includes a plurality of legs.

7. The certificate display stand of claim 1, further including a light fixture coupled to said post above said arms.

8. The certificate display stand of claim 1, further including a finial coupled to a top end of said post.

9. The certificate display stand of claim 8, wherein said finial includes a sculpture representing common subject matter of the certificates in said sleeves.

10. The certificate display stand of claim 4, wherein:
said post includes a hub to which said arms are coupled;
said hub includes a groove that is circular and positioned about the vertical axis of the post;
each of said arms includes a projection positioned in said groove; and
said projection is slidable in said groove such that said arms are movable about said hub to different positions.

11. The certificate display stand of claim 10, wherein said base includes a plurality of legs.

12. The certificate display stand of claim 11, further including a light fixture coupled to said post above said arms.

13. The certificate display stand of claim 12, further including a finial coupled to a top end of said post.

14. The certificate display stand of claim 13, wherein said finial includes a sculpture representing common subject matter of the certificates in said sleeves.
